(19) United States
(12) Patent Application Publication
(10) Pub. No.: US 2025/0294575 A1
(43) Pub. Date: Sep. 18, 2025

(54) METHODS FOR ACKNOWLEDGEMENT MECHANISMS BASED ON UNIFIED TCI FOR MTRP

(71) Applicant: INTERDIGITAL PATENT HOLDINGS, INC., Wilmington, DE (US)

(72) Inventors: Jonghyun Park, Syosset, NY (US); Afshin Haghighat, Ile-Bizard (CA); Loic Canonne-Velasquez, Dorval (CA); Moon IL Lee, Melville, NY (US); Paul Marinier, Brossard (CA); Mohammad Irfan, Chateauguay (CA)

(73) Assignee: INTERDIGITAL PATENT HOLDINGS, INC., Wilmington, DE (US)

(21) Appl. No.: 18/860,271

(22) PCT Filed: Apr. 26, 2023
(86) PCT No.: PCT/US2023/020021

§ 371 Date: Oct. 25, 2024

Related U.S. Application Data
(60) Provisional application No. 63/335,022, filed on Apr. 26, 2022.
(60) Provisional application No. 63/445,353, filed on Feb. 14, 2023.

(51) Int. Cl. H04W 72/231; H04L 1/1812; H04W 72/1273; H04W 72/21; H04W 76/20

(52) U.S. Cl. CPC H04W 72/231; H04L 1/1812; H04W 72/1273; H04W 72/21; H04W 76/20

(57) ABSTRACT

Systems, methods, and devices for one or more acknowledgment mechanisms for unified Transmission Configuration Indicator (TCI) and one or mor transmission reception point. In one example, a separate acknowledgement may be sent for each one of multiple downlink control information (DCI) transmissions with unified TCI, as well as a separate single acknowledgment for the one or more PDSCH transmissions related to each of the multiple DCI transmissions. In one or more of the acknowledgments, a HARQ-ACK codebook may include at least one HARQ-ACK bit based on reception of a PDSCH scheduled by at least one DCI and at least one bit based on successful reception of at least one DCI indicating the unified TCI(s). Reporting the separate acknowledgement may be based on when one or more predetermined, and/or configured, conditions are met.

### CROSS-REFERENCE TO RELATED APPLICATIONS

This application claims the benefit of U.S. Provisional Application No. 63/335,022, filed Apr. 26, 2022, and 63/445,353, filed Feb. 14, 2023, the contents of which are incorporated herein by reference.

### BACKGROUND

In some wireless systems, a device may send a transmission having a certain configuration or parameter(s). A receiving device needs an approach to understand those configurations and/or parameter(s), and a way to acknowledge those transmissions that are received successfully.

### SUMMARY

Systems, methods, and devices for one or more acknowledgment mechanisms for unified Transmission Configuration Indicator (TCI) and one or more transmission reception point. In one example, a separate acknowledgement may be sent for each one of multiple downlink control information (DCI) transmissions with unified TCI, as well as a separate single acknowledgment for the one or more PDSCH transmissions related to each of the multiple DCI transmissions. In one or more of the acknowledgments, a HARQ-ACK codebook may include at least one HARQ-ACK bit based on reception of a PDSCH scheduled by at least one DCI and at least one bit based on successful reception of at least one DCI indicating the unified TCI(s). Reporting the separate acknowledgement may be based on when one or more predetermined, and/or configured, conditions are met.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of separate ACK transmissions for confirming reception of unified TCIs;

FIG. 3 illustrates an example of separate ACK transmission for confirming reception of unified TCI(s);

FIG. 4A illustrates an example of separate ACK transmission for confirming reception of unified TCI(s);

FIG. 4B illustrates an example of separate ACK transmission for confirming reception of unified TCI(s);

FIG. 5 illustrates an example of a reliability enhancement on receiving DCIs for unified TCIs; and

FIG. 6 illustrates an example process of determining to send a DCI-ACK.

### DETAILED DESCRIPTION

As discussed herein, ‘a’ and ‘an’ and similar phrases are to be interpreted as ‘one or more’ and ‘at least one’. Similarity, any term which ends with the suffix ‘(s)’ is to be interpreted as ‘one or more’ and ‘at least one’. The term ‘may’ is to be interpreted as ‘may, for example’.

Table 1 is a non-exhaustive example of some acronyms used herein.

TABLE 1

| | |
|---|---|
| Configured grant | CG |
| Dynamic grant | DG |
| MAC control element | MAC CE |
| Acknowledgement | ACK |
| Block Error Rate | BLER |
| Bandwidth Part | BWP |
| Coherent Joint Transmission | C-JT |
| Cyclic Prefix | CP |
| Conventional OFDM (relying on cyclic prefix) | CP-OFDM |
| Channel Quality Indicator | CQI |
| Cyclic Redundancy Check | CRC |
| Channel State Information | CSI |
| Downlink Assignment Index | DAI |
| Downlink Control Information | DCI |
| Downlink | DL |
| Demodulation Reference Signal | DM-RS |
| Data Radio Bearer | DRB |
| Hybrid Automatic Repeat Request | HARQ |
| Long Term Evolution | LTE |
| Negative ACK | NACK |
| Multiple TRP | mTRP |
| Modulation and Coding Scheme | MCS |
| Multiple Input Multiple Output | MIMO |
| Non-Coherent Joint Transmission | NC-JT |
| New Radio | NR |
| Orthogonal Frequency-Division Multiplexing | OFDM |
| Physical Layer | PHY |
| Precoding Matrix Indicator | PMI |
| Physical Random Access Channel | PRACH |
| Primary Synchronization Signal | PSS |
| Random Access Channel (or procedure) | RACH |
| Random Access Response | RAR |
| Radio Front end | RF |
| Radio Link Failure | RLF |
| Radio Link Monitoring | RLM |
| Radio Network Identifier | RNTI |
| Radio Resource Control | RRC |
| Radio Resource Management | RRM |
| Reference Signal | RS |
| Reference Signal Received Power | RSRP |
| Received Signal Strength Indicator | RSSI |
| Service Data Unit | SDU |
| Sounding Reference Signal | SRS |
| Synchronization Signal | SS |
| Secondary Synchronization Signal | SSS |
| Semi-persistent scheduling | SPS |
| Supplemental Uplink | SUL |
| Transport Block | TB |
| Transport Block Size | TBS |
| Transmission Configuration Indicator | TCI |
| Transmission/Reception Point | TRP |
| Uplink | UL |
| Ultra-Reliable and Low Latency Communications | URLLC |
| Wireless Local Area Networks | WLAN |
| and related technologies | |
| (IEEE 802.xx domain) | |

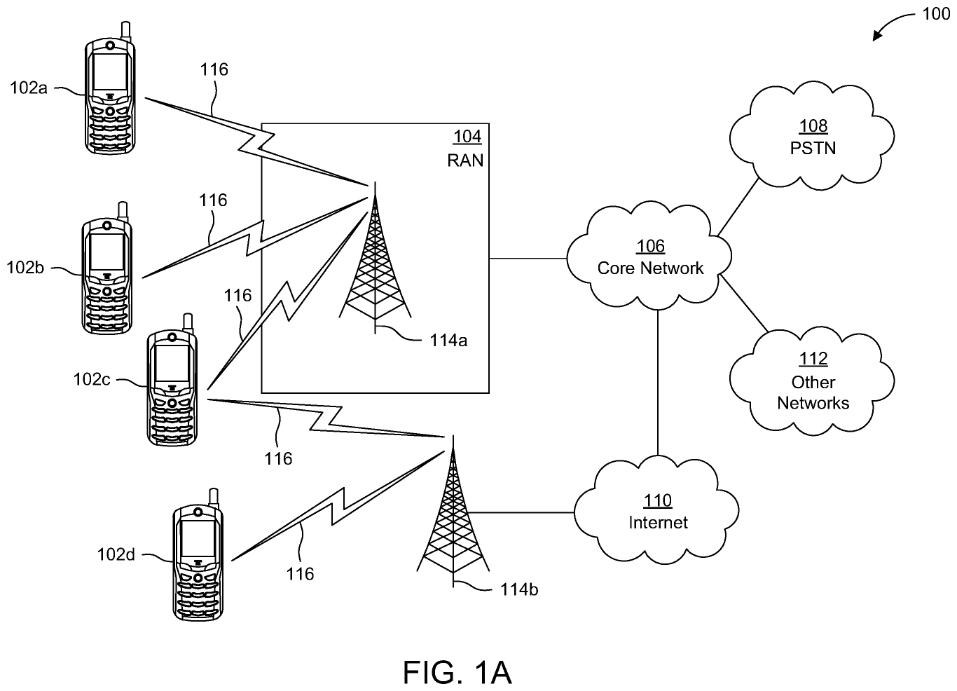

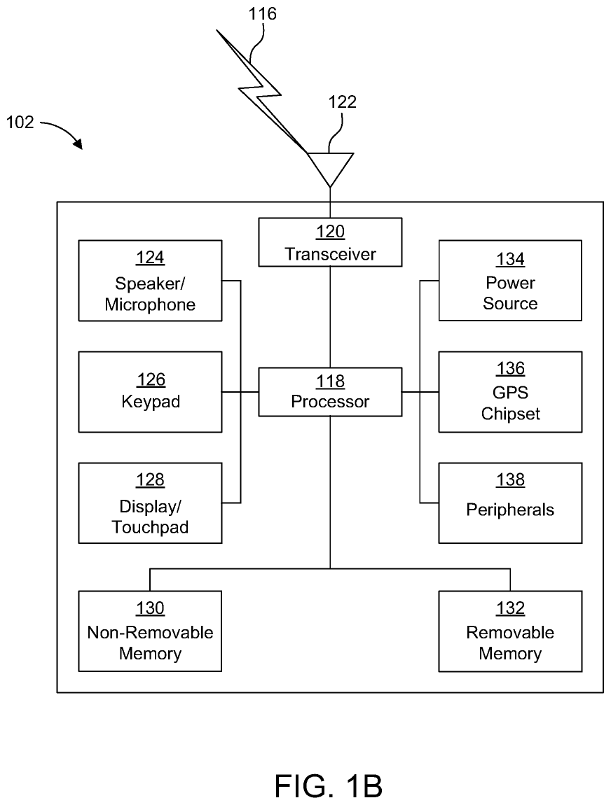

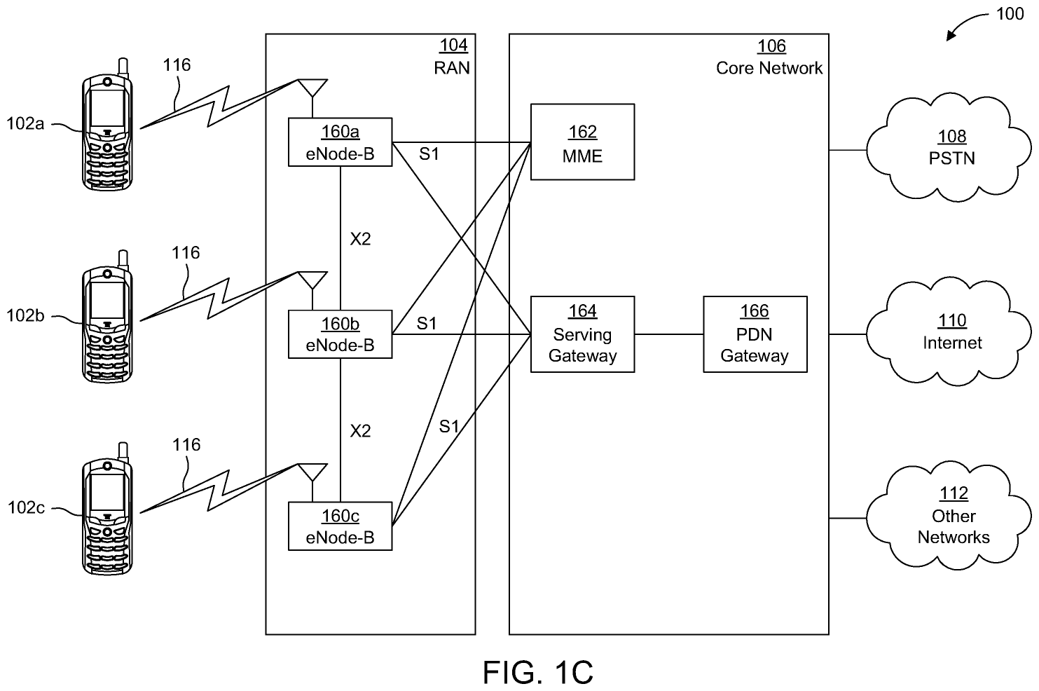

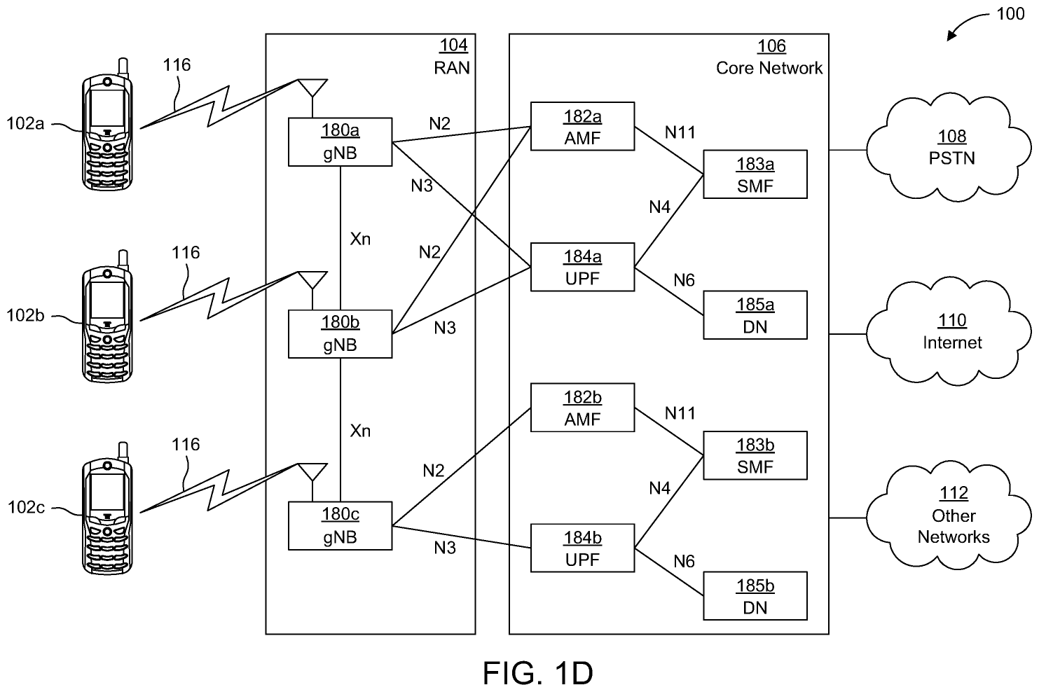

FIG. 1A is a diagram illustrating an example communications system 100 in which one or more disclosed embodimients may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a pubic switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a mixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like.

While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cel (not shown). These frequencies may be in licensed spectrum, unlicensed spectrum, or a combination of licensed and unlicensed spectrum. A cel may provide coverage for a wireless service to a specific geographical area that may be relatively fixed or that may change over time. The cel may further be divided into cell sectors. For example, the cel associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cel. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication ink (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or al of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless inks). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment. As discussed herein, reference to sending or transmitting may mean that a signal or transmission is transmitted using one or more of the elements described herein (e.g., WTRU may send a physical channel transmission using one or more transceivers or one or more transmitters; e.g., this may inherently require the use a processor operatively connected to the transmitter which sends the signal via one or more antennas). As discussed herein sending and transmitting, or send and transmit, may be interchangeable.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cel batteries (e.g., nickel-cadmium (NiCd), nickel-zinc (NiZn), nickel metal hydride (NiMH), lithium-ion (Li-ion), etc.), solar cels, fuels, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Realty and/or Augmented Realty (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or al of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or al of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cel (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may delver the traffic to the destination STA. The traffic between STAs within a BSS may be considered and/or referred to as peer-to-peer traffic. The peer-to-peer traffic may be sent between (e.g., directly between) the source and destination STAs with a direct ink setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., al of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by al STAs in the BSS. The bandwidth of the primary channel may be set and/or limited by a STA, from among al STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, al available frequency bands may be considered busy even though a majority of the available frequency bands remains idle.

In the United States, the available frequency bands, which may be used by 802.11ah, are from 902 MHz to 928 MHz. In Korea, the available frequency bands am from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cels, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cel (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handing of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handing user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or al, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or mom, or al, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or al, functions while being fully or partially implemented and/or deployed as part of a wired and/or wireless communication network in order to test other devices within the communication network. The one or mom emulation devices may perform the one or more, or al, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including al, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment Direct RF coupling and/or wireless communications via RF circuitry (e.g., which may include one or more antennas) may be used by the emulation devices to transmit and/or receive data.

A WTRU may send or receive a physical channel transmission or reference signal (RS) according to at least one spatial domain filter. As used herein, the term ‘beam’ may be used to refer to a spatial domain filter, and the two words may be interchangeable. As used herein, RS may be interchangeably used with one or mom of RS resource, RS resource set, RS port, and/or RS port group, unless otherwise noted. As used herein, RS may be interchangeably used with one or more of SSB, Channel State Information Reference Signal (CSI-RS), Sounding Reference Signal (SRS), and/or Demodulation Reference Signal (DM-RS), unless otherwise noted.

In some cases, the WTRU may send a physical channel transmission or signal using the same spatial domain filter as the spatial domain filter used for receiving an RS (e.g., CSI-RS) or a Synchronization Signal Block (SS block). The WTRU transmission may be referred to as a ‘target’, and the received RS or SS block may be referred to as a “reference” or “source” (e.g., the two transmissions differ in type). In such a case, the WTRU may be said to transmit the target physical channel or signal according to a spatial relation with a reference to such a RS or SS block.

In some cases, the WTRU may send a first physical channel transmission or signal according to the same spatial domain filter as a spatial domain filter used for sending a second physical channel transmission or signal. The first and second transmissions may be referred to as a “target” and “reference” (or “source”), respectively (e.g., where the second transmission is sent earlier than the first transmission, or). In such a case, the WTRU may be said to send the first (target) physical channel transmission or signal according to a spatial relation with a reference to the second (reference) physical channel or signal.

A spatial relation may be implicit, configured by RRC, or signaled by MAC CE or DCI. For example, a WTRU may implicitly send a PUSCH transmission and DM-RS of a PUSCH according to the same spatial domain filter as an SRS indicated by an SRS resource indicator (SRI) indicated in a DCI or configured by RRC. In another example, a spatial relation may be configured by RRC for an SRI or signaled by MAC CE for a PUCCH. As noted herein, “beam (e.g., analog beam)” may be equivalent to “spatial-domain (analog) filter/coefficients/information, etc.” As used herein, “beam indication” may be a one-way indication (e.g., from gNB to WTRU), between two signals (e.g., one is source and another is target); a beam indication may be equivalent, and interchangeable, with “spatial relation” or spatial relationship between the two signals, as used herein.

In some cases, the WTRU may receive a first (target) downlink channel transmission or signal according to the same spatial domain filter or spatial reception parameter as a second (reference) downlink channel or signal, thereby demonstrating an association between the target and the reference; note, the first transmission/signal may be later in time than the second transmission/signal. For example, such an association may exist between a physical channel such as PDCCH or PDSCH and its respective DM-RS. At least when the first and second signals are reference signals, such an association may exist when the WTRU is configured with a quasi-colocation (QCL) assumption type D between corresponding antenna ports. Such an association may be configured as a transmission configuration indicator (TCI) state. A WTRU may be indicated an association between a CSI-RS or SS block and a DM-RS by an index to a set of TCI states configured by RRC and/or signaled by MAC CE. Such an indication may also be referred to as a “beam indication”; and TCI state may also referred to a spatial relation. For example, a WTRU may receive a configuration message that includes a TCI state, which the WTRU may then use to determine the spatial domain filter for a target based on a reference (e.g., receiving a RS, then based on the configured TCI state, determining a spatial domain filter for sending a physical channel transmission).

In another example, each configured TCI-state (e.g., a TCI-state information element (IE) in RRC) may include a source RS (e.g., a CSI-RS resource ID, or an SSB-index, etc.). Each TCI-state (e.g., IE) may be configured under a physical (target) channel/signal. For instance, a CORESET (e.g., for a PDCCH) may be configured with a TCI-state. This means the WTRU may monitor the PDCCH via the CORESET by using a spatial-domain filter derived by using a (source/reference) RS indicated in the TCI-state. This example may represent an individual spatial relation. In other examples, there may be a need for an instance where there is a multiple spatial relation, where a single TCI state (source/reference) is applicable to multiple targets (e.g., a common TCI state, or a unified TCI state).

A unified TCI (uTCI) (e.g., a uTCI state, a common TCI, a common beam, a common RS, etc.) may refer to a beam/RS to be (e.g., simultaneously) used for multiple physical channels/signals. As used herein, the term TCI may comprise a TCI state (e.g., an IE) that includes at least one source RS to provide a reference (e.g., WTRU assumption) for determining QCL and/or spatial filter of the target channel/transmission/signal. As used herein, unified TCI may be interchangeably used with one or more of unified TCI-states, TCI, and TCI state, as long as the functionality for simultaneously applying it to multiple physical channels/signals is applied, unless otherwise noted.

The WTRU may be configured with a first mode for unified TCI (e.g., SeparateDLULTCI mode) where an indicated unified TCI (e.g., the first unified TCI or the second unified TCI) may be applicable for either downlink (e.g., based on the first unified TCI) or uplink (e.g., based on the second unified TCI).

In an example of the first mode, a WTRU may receive (e.g., from a base station) an indication of a first unified TCI to be used/applied for both a downlink control channel (e.g., PDCCH) and a downlink shared channel (e.g., PDSCH) (e.g., and a downlink RS). The source reference signal(s) in the first unified TCI may provide common QCL information at least for WTRU-dedicated reception on the PDSCH and al, or subset of, a control resource set (CORESET)s in a component carrier (CC). In an example, a WTRU may receive (e.g., from a base station) an indication of a second unified TCI to be used/applied for both an uplink control channel (e.g., PUCCH) and an uplink shared channel (e.g., PUSCH) (e.g., and an uplink RS). The source reference signal(s) in the second unified TCI may provide a reference for determining common UL TX spatial filter(s) at least for dynamic-grant/configured-grant based PUSCH and all, or a subset of, dedicated PUCCH resources in a CC.

The WTRU may be configured with a second mode for unified TCI (e.g., JointTCI mode) where an indicated unified TCI (e.g., the third unified TCI, or said another way a uTCI not related to the first and second referenced above) may be applicable for both downlink and uplink (e.g., based on the third unified TCI).

In an example of the second mode, a WTRU may receive (e.g., from a base station) an indication of a second unified TCI to be used/applied commonly for a PDCCH, a PDSCH, a PUCCH, and/or a PUSCH (e.g., and a DL RS and/or a UL RS).

In one case, for these two modes, First mode (SeparateDLULTCI mode) and Second mode (JointTCI mode), only one of the modes may be used (e.g., by RRC configuration), so the uTCI(s) used for each mode may not be related at all to the uTCI(s) of the other mode.

The WTRU may determine a TCI state applicable to a transmission or reception by first determining a Unified TCI state instance applicable to the transmission or reception, then determining a TCI state corresponding to the Unified TCI state instance. A transmission may comprise of at least PUCCH, PUSCH, and/or SRS. A reception may comprise of at least PDCCH, PDSCH, and/or CSI-RS. As used herein, a unified TCI state instance may also be referred to as a TCI state group, TCI state process, unified TCI pool, a group of TCI states, a set of time-domain instances/stamps/slots/symbols, and/or a set of frequency-domain instances/RBs/subbands, etc. A unified TCI state instance may be equivalent or identified to a CORESET Pool identity (e.g., CORESETPoolIndex, a TRP indicator, and/or the like).

As used herein, a transmission and reception point (TRP) may be interchangeably used with one or more of TP (transmission point), RP (reception point), RRH (radio remote head), DA (distributed antenna), BS (base station), a sector (of a BS), and/or a cell (e.g., a geographical cel area served by a BS), unless otherwise noted. Hereafter, Multi-TRP may be interchangeably used with one or more of MTRP, M-TRP, and multiple TRPs, unless otherwise noted. In one case, a TRP may be a kind of “a remote antenna part/hardware” that may be connected (e.g., optical fiber wireline, etc.) to a base station (e.g., a “gNB site”). In one case, if many TRPs are used in at one base station, “virtual cells” (e.g., each per each TRP) may be formed, although those virtual cels may be associated with a same physical cel ID (PCID). In one case, there may be on TRP at a base station (e.g., where each TRP may be regarded as almost equivalent to a base station, or one sector of the base station). In one case, the use of a TRP may be applicable to MIMO use cases, referring more specifically to a part of a base station of a wireless system.

A WTRU may be configured with, or may receive configuration of, one or more TRPs to which the WTRU may transmit and/or tom which the WTRU may receive. The WTRU may be configured with one or more TRPs for one or more cels. A cel may be a serving cell or a secondary cel.

A WTRU may be configured with at least one RS for the purpose of channel measurement. This RS may be denoted as a Channel Measurement Resource (CMR) and may comprise a CSI-RS, SSB, or other downlink RS transmitted from the TRP to a WTRU. A CMR may be configured or associated with a TCI state. A WTRU may be configured with a CMR group where CMRs transmitted from the same TRP may be configured. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group.

A WTRU may be configured with, or receive configuration of, one or more pathloss (PL) reference groups (e.g., sets) and/or one or more SRS groups, SRS resource indicator (SRI), and/or SRS resource sets. A PL reference group may correspond to or may be associated with a TRP. A PL reference group may include, identify, correspond to or be associated with one or more TCI states, SRIs, reference signal sets (e.g., CSI-RS set, SRI sets), CORESET index, and or reference signals (e.g., CSI-RS, SSB).

A WTRU may receive a configuration (e.g., any configuration described herein). The configuration may be received from a base station (e.g., gNB or TRP). For example, the WTRU may receive configuration of one or more TRPs, one or more PL reference groups, and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to TRP2 with SRS in the second resource set. The configuration may be via RRC signaling.

As used herein TRP, PL reference group, SRI group, and/or SRI set may be used interchangeably. For example, one TRP may be identified as a kind of DL transmission entity that is associated with RSs belonging to one pathloss (PL) reference group. For example, one TRP may be identified as a kind of a UL reception entity that is associated with SRSs belonging to one SRS resource indicator (SRI) group. For example, one TRP may be identified as a kind of a UL reception entity that is associated with SRS resource sets belonging to one SRI set.

A WTRU may report a subset of channel state information (CSI) components, where CSI components may correspond one or more of a CSI-RS resource indicator (CRI), a SSB resource indicator (SSBRI), an indication of a panel used for reception at the WTRU (e.g., a panel identity or group identity), measurements such as L1-RSRP, L1-SINR taken from SSB or CSI-RS (e.g., cri-RSRP, cri-SINR, ssb-Index-RSRP, ssb-index-SINR), and other channel state information such as at least rank indicator (RI), channel quality indicator (CQI), precoding matrix indicator (PMI), Layer Index (LI), and/or the like.

A property of a grant or assignment may comprise of one or more of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or, any parameter provided in a DCI, by MAC or by RRC for the scheduling the grant or assignment.

An indication by DCI may comprise of one or more of the flowing: an explicit indication by a DCI field or by RNTI used to mask CRC of the PDCCH; and/or, an implicit indication by a property such as DCI format, DCI size, Coreset or search space, Aggregation Level, first resource element of the received DCI (e.g., index of first Control Channel Element), where the mapping between the property and the value may be signaled by RRC or MAC.

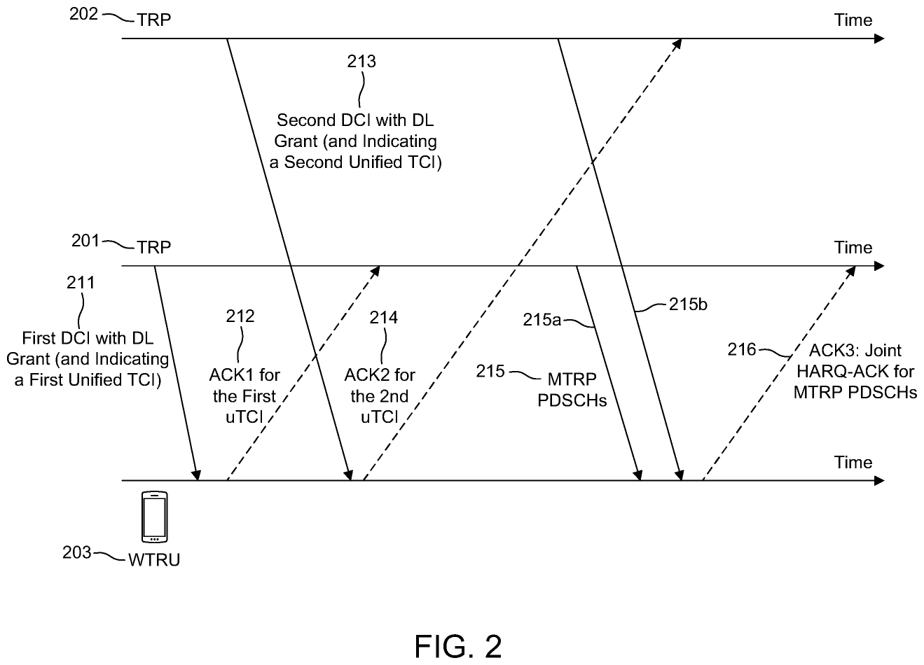

In one approach, the WTRU may generate a HARQ-ACK codebook based on reception of at least one DCI (e.g., the first DCI and/or the second DCI, as shown in FIG. 2, for example) that may indicate at least one unified TCI (e.g., the first unified TCI and/or the second unified TCI). The HARQ-ACK codebook may (e.g., also) include at least one HARQ-ACK bit based on reception of a PDSCH, such as scheduled by the first DCI and/or the second DCI. The HARQ-ACK codebook may comprise the joint HARQ-ACK for the MTRP PDSCH(s) and at least one bit based on reception of the at least one DCI indicating the unified TCI(s). For example, the WTRU may receive a first DCI with a first uTCI, a second DCI with a second uTCI, and a MTRP PDSCH; the WTRU may send a HARQ-ACK codebook that ACK al of the received transmissions. This may improve reliability and robustness by reducing a mismatch probability between the WTRU and the base station in setting/applying unified TCI(s) (e.g., the first unified TCI and/or the second unified TCI), based on at least one separated bit being comprised inserted/added in a HARQ-ACK codebook (e.g., for the joint HARQ-ACK for the MTRP PDSCH(s)), where the at least one separated bit may represent on whether the unified TCI(s) indicated by the at least one DCI is/are successfully received.

The WTRU may generate a HARQ-ACK codebook based on reception of at least one DCI that may indicate at least one unified TCI instance. In some situations, the WTRU may be configured to include or append at least one bit in a HARQ-ACK codebook to provide an indication or confirmation of reception of the at least one unified TCI indication.

The WTRU may append one bit for each configured unified TCI instance. The WTRU may set the bit corresponding to a unified TCI instance to a first value if it received at least one DCI containing an indication for that TCI instance, and to a second value otherwise.

The WTRU may append at least one bit indicating how many distinct unified TCI instances am indicated within the at least one DCI. For example, the WTRU may set a bit to a first value if a single unified TCI instance is indicated within the at least one DCI and to a second value if two, or more, unified TC instances am indicated. This may allow the scheduler to detect if the WTRU missed al DCI's indicating a unified TCI instance.

The WTRU may determine that it missed at least one DCI based on at least one counter downlink assignment index (DAI) and/or total DAI values received from the at least one DCI. The WTRU may append a bit to the HARQ-ACK codebook indicating whether or not the WTRU missed at least one DCI.

The WTRU may append a bit set to a first value in case the WTRU determines that no DCI is missed or in case it received indications for more than one unified TCI instances. Otherwise, the WTRU may append a bit set to a second value.

The WTRU may determine whether or not to append at least one bit based on the number of at least one DCI and received counter DAI and/or total DAI values indicated in the at least one DCI. For example, the WTRU may append the at least one bit if the number of at least one DCI is more than N where N is a pre-defined or configured number. For example, N may be one (1).

A WTRU may (e.g., be configured to) communicate with more than one TRP (e.g., MTRPs). As used herein, for illustrative purposes, more than one TRP may comprise TRP1 and TRP2, however the proposed approaches and processes may equally (e.g., equivalently, extendedly, etc.) be employed for cases with more than two TRPs being used for communication (for DL/UL) with the WTRU. In an example, one of the MTRPs may be a primary TRP (e.g., the TRP1).

FIG. 2 illustrates an example of a separate ACK transmission for confirming reception of a unified TCI(s). In this scenario, there may be three entities: a WTRU 203, a TRP 201, and a TRP 203. The arrows shown may indicate a transmission, and a corresponding reception, and time may be shown in the horizontal axis of the figure. As shown in the example, the WTRU 203 may receive a first DCI 211 indicating a first unified TCI (e.g., to be applied for multiple channels/signals), where the first DCI may (e.g., also) comprise a scheduling grant for a first PDSCH. The WTRU may receive a second DCI 213 indicating a second unified TCI (e.g., to be applied for multiple channels/signals), where the second DCI may (e.g., also) comprise a scheduling grant for a second PDSCH. The WTRU 203 may send an ACK for each reception of DCI including each uTCI (e.g., 212 shows ACK1 for successful reception of the first DCI including reception of the first uTCI, and 214 shows ACK2 for successful reception of the second DCI including reception of the second uTCI). Generally, an ack may be for a DCI, a uTCI, and/or both.

The first PDSCH 215a and the second PDSCH 215b may be associated with each other as a MTRP PDSCH 215 (e.g., where the first PDSCH 215a may be transmitted from TRP 201 and the second PDSCH 215b may be transmitted from TRP 202). In some instances, the WTRU may transmit a joint HARQ-ACK 216 (e.g., ACK3) in response to receiving the first PDSCH and the second PDSCH, where the joint HARQ-ACK comprises a first bit indicating whether the first PDSCH is successfully received and a second bit indicating whether the second PDSCH is successfully received.

In an example, transmitting the joint HARQ-ACK may (also) be interpreted as (e.g., may comprise/include/imply) an acknowledgement of a successful reception of the first DCI informing the first unified TCI. Transmitting the joint HARQ-ACK may (also) be interpreted as (e.g., may comprise/include/imply) an acknowledgement of a successful reception of the second DCI informing the second unified TCI. Transmitting the joint HARQ-ACK may (also) be interpreted as (e.g., may comprise/include/imply) an acknowledgement of a successful reception of both the first DCI informing the first unified TCI and the second DCI informing the second unified TCI (e.g., a situation where there would be no need for 212 ACK1 and 213 ACK2 as shown in FIG. 2).

In an example, the WTRU may fail to receive one of the first DCI and the second DCI (e.g., due to a blockage, severe shadowing owing to obstacles, deep fading in wireless channel, and/or the like). In response to not receiving (e.g., failure) one of the first DCI and the second DCI, the WTRU may transmit the joint HARQ-ACK that comprises a bit indicating a NACK. The original sender (e.g., TRP, base station, etc.), may receive the joint HARQ-ACK comprising the bit indicating the NACK, where the sender may interpret (e.g., mistakenly) the NACK as a failure of receiving one of the first PDSCH and the second PDSCH but may not interpret the NACK is due to a failure of receiving one of the first DCI and the second DCI. Based on this interpretation, the sender may continue to use the first unified TCI and the second united TCI for communication with the WTRU, but the WTRU may not know one of the first unified TCI and the second unified TCI due to the reception failure of the one. Such an error in communication may cause performance degradation in wireless communications between the sender and the WTRU. Accordingly, there is a need to improve robustness on unified TCI indications for MTRP, by implementing one or more improved and/or new acknowledgement mechanisms. For example, in the case of MDCI-MTRP with a joint HARQ-ACK mode (ackNackFeedbackMode=join) being configured, and/or in the case of PDCCH repetitions (e.g., and PDSCH repetitions being applied together). Further, there is a need to determine a reference to apply a configured beam application time (BAT).

One approach to address this issue may be to have the WTRU (e.g., be configured to) transmit an (e.g., separate) acknowledgement (e.g., message) in response to (e.g., successfully) receiving at least one of the first unified TCI and the second unified TCI, such as being separated from the joint, or data only, HARQ-ACK transmission (e.g., as shown in FIG. 2). In an example, the WTRU may (e.g., be configured/indicated to) transmit a first ACK in response to (e.g., successfully) receiving the first unified TCI (e.g., indicated by the first DCI), which may be independent from a HARQ-ACK (e.g., the joint HARQ-ACK) transmitted in response to a PDSCH, such as scheduled by the first DCI. The WTRU may (e.g., be configured/indicated to) transmit a second ACK in response to (e.g., successfully) receiving the second unified TCI (e.g., indicated by the second DCI), which may be independent from a HARQ-ACK (e.g., the joint HARQ-ACK) in response to a PDSCH, such as scheduled by the second DCI. This may improve reliability and robustness by reducing a mismatch probability between the WTRU and the base station in setting/applying unified TCI(s) (e.g., the first unified TCI and/or the second unified TCI), based on a separated acknowledgement for the unified TCI(s) reception from a HARQ-ACK for data reception.

In some cases, an additional ACK may be used to confirm the reception of a united TCI indication (e.g., in DCI), wherein the additional ACK may be in a similar format (e.g., uplink channel, resource, signal) as HARQ-ACK used for PDSCH or semi-persistent-scheduling (SPS) release.

When a WTRU receives a DCI scheduling a PDSCH, the WTRU may report HARQ-ACK corresponding to the PDSCH received, and the reported HARQ-ACK may confirm the successful reception of the PDSCH and/or the scheduling DCI. As used herein, a DCI scheduling a PDSCH or a PUSCH may be interchangeably used with a scheduling DCI.

In one case, a WTRU may report an additional ACK when a scheduling DCI includes one or more of the following information and/or contents, wherein the additional ACK may be a separate ACK which may be reported earlier than HARQ-ACK associated with a scheduled data (e.g., PDSCH) from the scheduling DCI: united TCI; unified TCI for more than one TRP; unified TCI for primary (or secondary) TRP; and/or, priority indicator (e.g., present when the DCI is used for URLLC use case). The WTRU may (e.g., be configured to) apply or use the indicated unified TCI(s) after a first beam application time (BAT) parameter from receiving the DCI and/or transmitting the additional ACK. The first BAT parameter may be configured by a base station and/or reported from the WTRU as a part of WTRU capability parameters. The WTRU may (e.g., be configured to) apply or use the indicated unified TCI(s) after a second beam application time (BAT) parameter from receiving the scheduled data and/or transmitting the HARQ-ACK. The second BAT parameter may be configured by a base station and/or reported from the WTRU as a part of WTRU capability parameters. The first BAT parameter may be identical to the second BAT parameter or may follow to use the second BAT parameter. The second BAT parameter may be different from (e.g., shorter than) the second BAT parameter.

As referenced hemin, the additional ACK may be interchangeably used as separate ACK, first ACK, unified TCI confirmation, unified TCI confirmation indication, DCI-ACK, DCI confirmation ACK, and/or conditional ACK

The additional ACK may provide a shorter time duration of applying (e.g., based on the first BAT and/or based on transmitting the additional ACK) a unified TCI when the PDSCH scheduling offset is large and reduce mis-reception of the confirmation of beam indication.

In one case, a WTRU may report an additional ACK when one or more predetermined (e.g., and/or configured) conditions are met, thereby reducing the uplink resource overhead for the additional ACK. These one or more conditions that are predetermined and/or configured may be used in combinations of two or more, or individually.

For example, one condition may include where an indicated unified TCI in the scheduling DCI is different from the previous (e.g., currently used) one.

For example, one condition may include a beam quality of the current common beam (e.g., unified TCI) is below a threshold. In one instance, the beam quality may be based on beam measurement of a reference signal associated with the current common beam (e.g., an RS QCL-ed with the unified TCI currently used). In another instance, the beam quality may be determined based on the number of HARQ-ACK (e.g., negative ACK) occurred in recent PDSCH receptions, or PUSCH transmissions. The number of NACK may be counted within a time window, wherein the time window may be configured or pre-determined.

For example, one condition may include where a different value of WTRU-panel index (e.g., associated with the indicated unified TCI) has been reported (e.g., within a time window Z). In one instance, the WTRU may report/transmit a (e.g., preferred) WTRU-panel index (e.g., among multiple WTRU-panel indexes being reported as a part of WTRU capability and/or being configured from a gNB) and/or preferred beam index(s), such as via a beam reporting instance, where the reported WTRU-panel index may represent a preferred WTRU-panel for communication with the base station. For example, similar WTRU-panel related behavior/indication/reporting may affect the condition(s).

For example, one condition may include at least one BFR-related condition being met (e.g., after WTRU sends a BFR request, receives a BFR response, and/or receives a DCI via a BFR-CORESET).

For example, one condition may include a PDSCH scheduling offset, and/or PUSCH scheduling offset, is larger than a threshold (e.g., the thresholds for PDSCH and PUSCH may have a different value).

For example, one condition may include where a HARQ-ACK transmission timing (e.g., for PDSCH) is larger than a threshold.

For example, one condition may include where the number of repetitions for PDSCH, and/or PUSCH, is larger/smaller than a threshold.

For example, one condition may include where a status of HARQ-ACK for the scheduled PDSCH. For example, if negative ACK (NACK) is determined for the scheduled PDSCH, the additional ACK is reported.

For example, one condition may include where a sub-slot based PDSCH, or PUSCH, scheduling is used; therefore low-latency high reliability transmission may be required.

For example, one condition may include where a coverage enhancement mode of operation is used (e.g., coverage enhancement scheme including ‘TB (e.g., transmission block) processing over multi-slot’ (TBoMS) and DMRS time domain bundling is used).

For example, one condition may include where system parameters (e.g., bandwidth, subcarrier spacing, CP length, etc.) am associated with additional ACK transmission.

In one case, a WTRU may be indicated (e.g., explicitly/implicitly) for reporting the additional ACK In such a case, one or more of the following may apply: the scheduling DCI may be scrambled with two RNTIs, where the WTRU may report the additional ACK when the scheduling DCI is scrambled with a first RNTI, otherwise, the WTRU may skip reporting the additional ACK; an explicit bit field in the scheduling DCI may indicate the request of additional ACK reporting; each unified TCI state may be configured to report additional ACK or not and/or, each TRP (e.g., based on a TRP-indicator, a value of CORSETPoolIndex, etc.) may be associated (e.g., configured/indicated) with whether additional ACK is to be reported by a WTRU or not when the WTRU receives (e.g., by a DCI) a unified TCI indication (e.g., being associated with a TRP, such as which TRP of the each TRP).

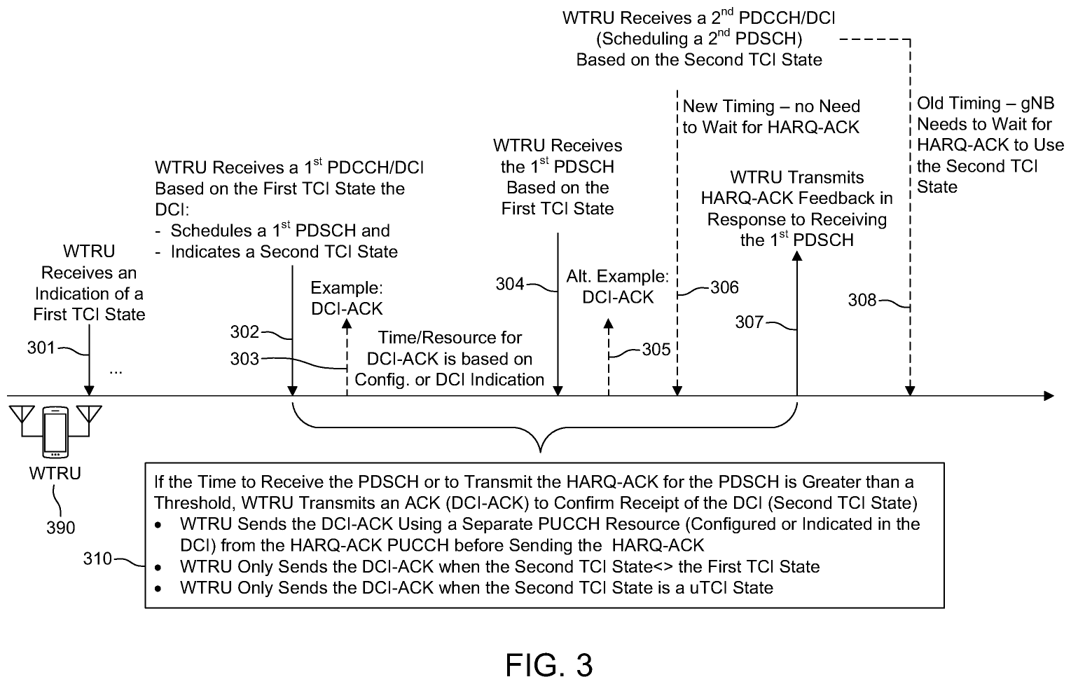

FIG. 3 illustrates an example of separate ACK transmission for confirming reception of unified TCI(s). As shown, at 301 a WTRU may (e.g., be configured to) receive an indication of a first TCI state (e.g., as a unified TCI). At 302, the WTRU may receive a first PDCCH based on the first TC state. The first PDCCH may carry a first DCI scheduling a first PDSCH, and may indicate a second TCI state.

At 303 and/or 305, the WTRU may transmit an ACK. If a time duration associated with at least one of the first PDSCH reception or the transmission of HARQ feedback associated with the first PDSCH is determined to be greater than a threshold (e.g., the threshold may be based on one or more predetermined, and/or configured, conditions as described herein), then the WTRU may (e.g., be configured to) transmit an ACK (e.g., the DCI-ACK 303 and/or 305), confirming reception of the first DCI.

At 304, the WTRU may receive the first PDSCH based on the first TCI state. At 307, the WTRU may transmit the HARQ feedback associated with the first PDSCH. In an example, the DCI-ACK (e.g., 305) may be transmitted before the HARQ feedback transmission (e.g., 307), which may provide benefits (e.g., in terms of latency reduction and/or robustness of beam or TCI update) in that a receiver (e.g., base station) who receives the DCI-ACK (e.g., 305) does not need to wait for HARQ-ACK in order to make sure that the WTRU successfully received the first DCI. In such a case, the WTRU may receive a second PDCCH prior to transmitting the HARQ feedback associated with the first PDSCH—this may be possible as a result of the techniques disclosed herein (e.g., in legacy scenarios the base station needed to wait for HARQ-ACK to use the second TCI state).

In some instances, the WTRU may (e.g., be configured to) apply or use the second TCI state, such as a unified TCI applicable to multiple channel(s) and/or signal(s)) after a beam application time (BAT) parameter upon transmitting the DCI-ACK as a new beam application timeline based on transmitting the DCI-ACK (e.g., instead of after the BAT parameter after transmitting the HARQ-ACK as an old beam application timeline, which may reduce the latency of beam or TCI update). Explained another way, if the WTRU transmits the DCI-ACK at time t1, the WTRU may start to use/apply the second TCI state at t2, where t2=t1+BAT. The BAT parameter may be configured by a base station and/or reported from the WTRU as a part of WTRU capability parameters.

The transmission of the ACK (e.g., the DCI-ACK 303 or 305) confirming reception of the first DCI may be (e.g., further) conditioned on when at least one of the following conditions is met the second TCI state is different from the first TCI state; and/or, the first and second TCI states are unified TCI states where an indicated unified TCI state applies to more than one channel type (e.g., more than one channel type and/or signal type). In one instance, as shown at 310, if the time to receive the PDSCH or to transmit the HARQ-ACK for the PDSCH is greater than a threshold, then the WTRU may transmit an ACK (DCI-ACK) to confirm receipt of the DCI (e.g., the second TCI state).

At 308, where 306 does not occur, the WTRU may receive a second PDCCH carrying a second DCI where the second PDCCH is received after transmitting the HARQ feedback, and is received based on the second TCI state.

In some instances, the WTRU may (e.g., be further configured to) transmit the HARQ feedback using a second PUCCH resource and the ACK (e.g., the DCI-ACK) for confirming the DCI reception using a first PUCCH resource (e.g., where the first PUCCH resource may be determined based on configuration or an indication in the first DCI).

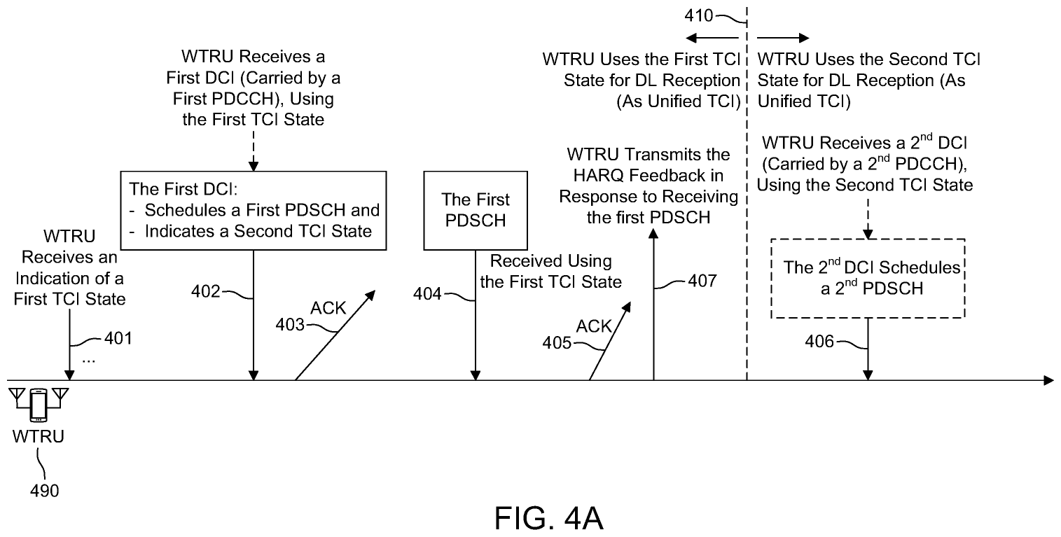

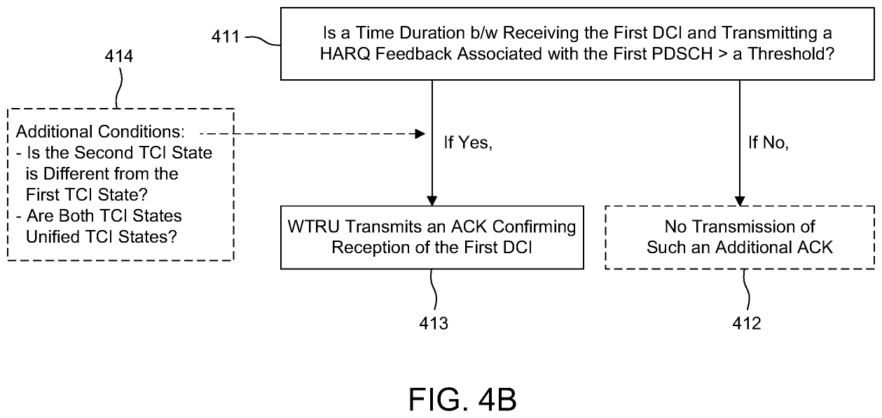

FIG. 4A illustrates an example of separate ACK transmission for confirming reception of unified TCI(s). As shown, at 401 a WTRU may (e.g., be configured to) receive an indication of a first TCI state (e.g., as a unified TCI). At 402, the WTRU may receive a first PDCCH based on the first TC state where the first PDCCH may cany a first DCI scheduling a first PDSCH and may indicate a second TCI state.

At 403 and/or 404 an ACK for the DCI may be sent, and when it is sent may depend on one or more conditions disclosed herein. As shown in FIG. 4B, in determining whether and when to send a DCI-ACK, a WTRU may determine whether a time duration between receiving the first DCI and transmitting a HARQ feedback associated with the first PDSCH greater than a threshold (e.g., 411). If it is not, then there may not be an additional ACK transmitted (e.g., 412). If yes, then the WTRU may transmit an ACK confirming receipt of the first DCI (e.g., 413). In some instances, there may be additional conditions for transmitting the DCI-ACK (e.g., 414), such as: whether the second TCI state different from the first TCI state; and/or, whether both TCI states (first and second) are unified TCI states.

At 404, the WTRU may receive the first PDSCH based on the first TCI state. At 407, the WTRU may transmit the HARQ feedback associated with the first PDSCH. In an example, the DCI-ACK may be transmitted before the HARQ feedback transmission, which may provide benefits (e.g., in terms of latency reduction and/or robustness of beam or TCI update) in that a receiver (e.g., base station) who receives the DCI-ACK does not need to wait for HARQ-ACK in order to make sure that the WTRU successfully received the first DCI.

In some instances, the WTRU may (e.g., be configured to) apply or use the second TCI state, such as a unified TCI applicable to multiple channel(s) and/or signal(s)) after a beam application time (BAT) parameter upon transmitting the DCI-ACK as a new beam application timeline based on transmitting the DCI-ACK (e.g., instead of after the BAT parameter after transmitting the HARQ-ACK as an old beam application timeline, which may reduce the latency of beam or TCI update). Explained another way, if the WTRU transmits the DCI-ACK at time t1, the WTRU may start to use/apply the second TCI state at t2, where t2=t1+BAT. The BAT parameter may be configured by a base station and/or reported from the WTRU as a part of WTRU capability parameters.

At 406, the WTRU may receive a second PDCCH carrying a second DCI where the second PDCCH is received after transmitting the HARQ feedback, and is received based on the second TC state. Note, 410 illustrates a division in time where the WTRU may use the first TCI state for DL reception (e.g., as a unified TCI) or where the WTRU may use the second TCI state for DL reception (e.g., after 410) (e.g., as a unified TCI).

The WTRU may (e.g., be further configured to) transmit the HARQ feedback using a first PUCCH resource and the ACK (e.g., the DCI-ACK) for confirming the DCI reception using a second PUCCH resource (e.g., where the second PUCCH resource may be determined based on configuration or an indication in the first DCI).

In some cases, several PUCCH resource sets may be RRC configured, where each resource sets may contain several PUCCH resources (e.g., in NR systems). For example, up to 4 PUCCH resource sets each containing at least 8 PUCCH resources may be configured. Then, for a PUCCH resource set containing 8 resources, an indicated PUCCH resource indicator (PRI) in a received DCI may select the PUCCH resource for transmission. Further, for each PUCCH resource up to 8 different spatial information may be configured, where only one may be activated by MAC CE for transmission.

A WTRU may receive a dynamic indication for configuration of a common-beam (e.g., unified TCI) for future transmission and possibly reception. If the received indication is through a DCI, the DCI may or may not contain a scheduling grant. From a base station operation perspective, it is important to know whether a WTRU has successfully received the indicated common beams (e.g., unified TCIs). Therefore, it is important that a WTRU could be able to send an ACK corresponding to the correctly decoded DCI containing the indicated common beam (e.g., DCI-ACK).

In a multi-TRP operation, a WTRU may receive common beam information (e.g., unified TCI) corresponding to each TRP Ink by at least one dynamic indication, such as a DCI.

In some cases involving a single-DCI and multi-TRP indication, a WTRU may receive a unified TCI information for each TRP ink through cross TRP ink indication. In one case involving a single-DCI and multi-TRP indication, a unified TCI indication mechanism may be based on at least one of the following: an approach where a WTRU may receive a single DCI that may contain a first and a second (e.g., unified) TCI that are corresponding to a first and second TRP link, respectively; an approach where a WTRU may receive a single DCI that contains a single TCI and another implicit or explicit indication that determines whether the indicated TCI is applicable to the first or the second TRP ink (e.g., a DCI may contain a single bit indication to indicate whether the indicated TCI is applicable to a first or a second TRP-link); and/or, an approach where a WTRU may receive only a single DCI containing a single TCI information corresponding to the TRP link originating from the DCI, where from the determined TCI for the first ink, a WTRU may determine the TCI for the second TRP link from a preconfigured TCI association table that may be preconfigured by another dynamic indication, such as a MAC CE or by a semi-static configuration, such as by RRC. In the TCI association table, for each indicated TCI for a first TRP ink, a second TCI may correspond to the second TRP link that is configured.

In one case involving a single-DCI and multi-TRP indication, a WTRU may send an ACK to confirm the reception of the DCI using a configured PUCCH resource, such as the PUCCH resource indicated by a PUCCH resource indicator (PRI) in the received DCI. For transmission of the indicated PUCCH resource, a WTRU may do one or more of the followings for selection of the spatial filter: If a WTRU is transitioning from a non-unified TCI (e.g., a TCI-state, a beam index or TCI for an individual channel/signal) to a unified TCI state, the WTRU may use the most recent TCI state used within a configured time window, where the most recent TCI state may be associated with a recent uplink transmission, such as PUCCH, SRS, PUSCH, and/or the like; a WTRU may use the TCI state corresponding to the CORESET of the received DCI as the source reference signal for determination of a spatial beam (e.g., where the WTRU may use the TCI state associated to a CORESET only after when a time window is elapsed); and/or, a WTRU may use a preconfigured reference signal (e.g., a CRI, SSBRI, etc.), as the default source reference signal for determination of spatial information (e.g., for the ACK transmission, e.g., for the PUCCH resource).

In some cases involving a multi-DCI multi-TRP indication, a WTRU may receive unified TC information for each TRP Ink with or without a cross TRP ink indication. In one case, a unified TCI indication mechanism may be based on at least one of the followings: a WTRU may receive unified TCI information for each TRP ink through independent indication by more than one dynamic indication, such as DCIs; a WTRU may receive only a single DCI containing a single TCI information corresponding to the TRP link originating the DCI (e.g., associated to CORSETPoolIndex=0), where from the determined TCI for the first Ink, a WTRU can determine the TCI for the second TRP link from a preconfigured TCI association table that may be preconfigured by another dynamic indication (e.g., a MAC CE or by a semi-static configuration, e.g., by RRC), where in the TCI association table, for each indicated TCI associated to a first CORSETPoolIndex (e.g., first TRP link), a second TCI correspond to a second CORSETPoolIndex, (e.g., second TRP link) is configured (e.g., associated); for increased reliability, a WTRU may receive independent dynamic indications per TRP Ink (e.g., DCI) where each dynamic indication may contain a first and a second TCI that correspond to a first and second TRP Inks, respectively, therefore, in case of a failed decoding of one of the dynamic indications (e.g., DCIs) a WTRU may still be able to apply the received indications of unified TCI states for both TRP inks.

In one case involving a multi-DCI multi-TRP indication, a WTRU may confirm the reception of each received DCI using one or more of the corresponding configured PUCCH resources. In an approach where a WTRU may determine the unified TCI states for each TRP Ink independently form multiple dynamic indications (e.g., a DCIs), a WTRU may send separate ACKs to each TRP associated to each received DCI. In an example, a WTRU may use indicated PUCCH resources by the PRIs in a first and second received DCIs for transmission of the ACKs. In an example, the first received DC (e.g., from the first TRP) may comprise a first PRI field of the PRIs, and the second received DCI (e.g., from the second TRP) may comprise a second PRI field of the PRIs.

A WTRU may bundle multiple ACKs, and transmit a single ACK as the acknowledgment of successful decoding and determination of the TCIs (e.g., unified TCIs) for each link. In some situations, a WTRU may be configured with more than one PUCCH resources. For example, a WTRU may be configured with three PUCCH resources, a first, a second, and a third, where a first PUCCH resource may be used for transmission of bundled ACKs, a second PUCCH resource may be used for transmission of an ACK corresponding to a first DCI, and finally a third PUCCH resource that may be used for transmission of an ACK corresponding to the second DCI. If after decoding of a first DCI and determination of the first indicated (unified) TCI, the WTRU may receive a second DCI with a TC indication for the other TRP ink within a time window, a WTRU may use a first PUCCH resource for transmission of an ACK to acknowledge successful reception of both TCI states. In some instances, the time window may be fixed or based on a WTRU reported capability (e.g., and/or a configuration/indication from a gNB, e.g., for confirmation). Otherwise, if a WTRU successfully decodes the first DCI, and does not receive or successfully decode the second DCI, a WTRU may use a second PUCCH resource for acknowledging the TCI indication by the first DCI. A WTRU may use a third configured PUCCH resources for ACK transmission, if it decodes a second DCI and determines the TCI associated with the second TCI, outside the time window, or fails in decoding of the first DCI.

A WTRU may determine the unified TCI states for both TRP links from a single dynamic indication (e.g., a DCI), a WTRU may send a single ACK. For example, when a DCI carries only one TCI information, and the other TCI is determined through an association (e.g., a table with CORSETPoolIndex association), or a received DCI contains a first and a second TCI, a WTRU may send a single ACK to confirm successful determination and/or update of unified TCI states for both TRP links. A WTRU may use the indicated PUCCH resource by a PRI in a received DCI for ACK transmission.

In one case involving a multi-DCI multi-TRP indication, for transmission of the indicated PUCCH resource, a WTRU may do one or more behaviors for selection of the spatial filter.

For example, for selection of the spatial filter, if a WTRU is transitioning from a non-unified to a unified TCI state, a WTRU may use the most recent TCI state used for each TRP link, within a configured time window. The most recent TCI state may be associated with a recent uplink transmission, such as PUCCH, SRS, PUSCH, etc. In one instance, the time window may be fixed or based on a WTRU reported capability.

For example, for selection of the spatial filter, a WTRU may use the TCI state corresponding to the CORESET of the received DCI as the source reference signal for determination of spatial beam. In one instance, a WTRU may use the TCI state associated to a CORSET, only after when a time window is elapsed.

For example, for selection of the spatial filter, a WTRU may use a preconfigured reference signal for each TRP Ink (e.g., a CRI, SSBRI, etc.), as the default source reference signal for determination of a spatial information.

In some cases, a WTRU may receive more than one PDCCH candidate carrying the same grant (e.g., DCI) contents, where each candidate is sent from a different TRP with a different spatial filter in a TDM manner. A WTRU may receive each PDCCH candidate individually, or may soft-combine both candidates to improve the decoder's reliability. The grant may schedule a PDSCH transmission from a single TRP. The WTRU may send an ACK to confirm successful reception of the PDSCH. The WTRU may send an ACK (e.g., a beam confirming ACK) when a unified TCI command/indication is successfully received.

Based on one or more techniques disclosed herein, the multi-TRP PDCCH repetition candidates may carry a unified TCI, or a grant and a unified TCI. The WTRU may receive from the PDCCHs a grant scheduling a PDSCH from more than one TRP where each TRP may transmit with a spatial filter (e.g., TCI). A WTRU may determine that PDCCH and PDSCH repetitions are paired such that spatial filters are associated between repetition indices. For example, WTRU may receive PDCCH candidate 1 with TCI1, and PDCCH candidate 2 with TCI12. Then the WTRU may determine that PDSCH repetition 1 may be received with TCI1, and PDSCH repetition 2 may be received with TCI12.

In one case, for either PDCCH candidate repetition carrying a unified TCI, a WTRU may determine to send a beam confirming ACK to confirm successful reception of the unified TCI. A WTRU may send this ACK after the first, second, or both PDCCH candidates. A WTRU may receive a configuration for the PDCCH which may contain a configurable time offset K, and the WTRU may send the ACK after K seconds (e.g., slot, symbol, or a time unit) elapsed tom a reference PDCCH candidate. The WTRU may count a beam application time (BAT) for applying unified TCI(s) using the time offset K as a starting reference, and the WTRU may assume the unified TCI is applied after the BAT. The WTRU may, for example, based on an indication/configuration from a base station (e.g., gNB), determine the reference (PDCCH) candidate to be the PDCCH candidate that starts earlier in time, or the PDCCH candidate that ends later in time.

The WTRU may (e.g., based on an indication/configuration from a base station) determine to send two ACKs if the WTRU successfully decodes both PDCCH candidates individually. In this case, both candidates are reference for their respective ACK timing.

Alternatively, the WTRU may send two ACKs and one PDCCH candidate may serve as a reference for both ACKs. A WTRU may receive an inter-ACK timing offset in addition to the timing offset with respect to the reference PDCCH transmission. The second ACK may be sent delayed by the inter-ACK timing offset with respect to the first ACK.

Alternatively, the WTRU may (e.g., based on an indication/configuration from a base station) determine to send only one ACK after the first successfully decoded PDCCH candidate which may be the first or second PDCCH candidate. In this case, the successfully decoded candidate is the reference for the ACK timing. If the WTRU also successfully decodes the second candidate, then the WTRU may not send a second ACK

If the WTRU receives with soft-combining, the WTRU may send one ACK with the time offset calculated based on using either the first or second candidate as a reference.

Alternatively, to a WTRU sending a beam confirming ACK, a WTRU may send two ACKs which may correspond to the unified TCI ACK, and to the PDSCH ACK. A WTRU may receive a configuration for PUCCH with two PUCCH resources where each PUCCH resource is configured for one type of ACK The WTRU may receive in the DCI a PUCCH Resource Indicator (PRI) codepoint indicating two PRIs, or two PRI values may be explicitly indicated. A WTRU may determine the frequency location of a PUCCH resource (e.g., RB index, number of RBs) as a function of the PRI. The network may implicitly determine the type of ACK as a function of the WTRU's chosen PRI for ACK reporting.

For example, a WTRU may use a first PRI to send an ACK when the WTRU successfully receives the PDSCH scheduled by the repeated PDCCH. A WTRU may use a second PUCCH resource to send an ACK when the WTRU successfully receives the unified TCI indications. Each PUCCH may have its own reference PDCCH candidate, or they may both use the same reference PDCCH candidate for the timing with a different time offset per PUCCH resource.

The WTRU may use the second PUCCH resource to transmit the beam confirming ACK only when one or more of the following conditions are met the current common beam's (e.g., unified TCI's) signal quality (RSRP, RSSI, SNR, SINR) is below a threshold; the current common beam's (e.g., unified TCI's) signal quality is below the new beam's signal quality; after WTRU sends a BFR request, receives a BFR response, and/or receives a DCI via a BFR-CORESET; based on (e.g., the most) recent beam reporting contents (e.g., if the WTRU's last reported beam measurements was Y seconds before receiving the unified TCI command, and Y is less than a threshold, the WTRU may only transmit the ACK for the PDSCH, and not the second ACK for the unified TCI); based on a PDSCH scheduling offset (e.g., if the PDSCH is sent at a time larger than a threshold Y, then the WTRU may send the ACK and apply the new unified TCI for the PDSCH); based on a HARQ-ACK transmission timing; and/or, based on number of PDSCH repetitions.

For example, if the WTRU determines that the PDSCH is scheduled with more than X (e.g., X=4) repetitions, the WTRU may send the ACK and apply the new unified TCI for the repetitions occurring after the BAT. Each WTRU may receive a configuration for a WTRU-specific PUCCH resource for the unified TCI ACK. In this case, no other WTRU may use the same PUCCH resource and no collisions may occur.

A WTRU may report the two ACKs with a preconfigured ordering. For example, the WTRU may include the PDSCH ACK in the first PUCCH resource, and the unified TCI ACK in the second PUCCH resource, or vice-versa. A WTRU may receive a configured Ink between the PRI ordering in the DCI and the ACK usage type. Alternatively, the WTRU may dynamically determine the ordering based on one of the conditions highlighted above. For example, if a WTRU determines that the signal quality of a beam is below a threshold, a WTRU may determine to send the unified TCI ACK in the first PUCCH resource (e.g., first PRI); otherwise, use the second PRI. Similarly for the time index, a WTRU may select the PUCCH starting earliest/latest in time (e.g., with lowest/highest PDCCH to HARQ offset) for the unified TCI ACK as a function of one or more of the conditions being met. In another example, a WTRU may determine to use the PUCCH resource with a number of repetitions above a threshold for the unified TCI ACK (e.g., PRI with highest number of repetitions).

Alternatively, more than one WTRU (e.g., a group of WTRUs within the cel, oral WTRUs within the cell) may receive a configuration for the same second PUCCH resource (e.g., the one used for the unified TCI ACK). Any WTRU from the group may transmit an ACK for a unified TCI using the shared PUCCH resource.

A WTRU may be configured with a timer, and a WTRU may be configured with a counter which increments for each unified TCI ACK transmission. A WTRU may be limited to no more than Y unified TCI ACK transmissions within a X (e.g., second) period of time. For example, a WTRU may only use a PRI resource Y times in an X second period. If the WTRU uses the PRI resource more than Y times, then another PRI resource may be used. This may reduce the congestion when multiple users share the same PUCCH resource.

The network (e.g., a node, base station, etc.) may coordinate unified TCI indications to ensure that no collisions may occur on the PUCCH resource. For example, one unified TCI indication may be transmitted to a WTRU. The network may not transmit a unified TCI indication for another WTRU until it received an ACK from the first unified TCI indication. The network may monitor the PUCCH resource for any of the WTRUs configured in the group.

If a WTRU receives a configuration with only one PUCCH resource, and the WTRU determines that two ACKs (e.g., one for PDSCH, and one for the TCI indication) collide (e.g., they have the same time occupancy), then the WTRU may determine to send one ACK over the other based on a priority rule. For example, the WTRU may apply a priority rule where a unified TCI indication ACK is higher priority than a PDSCH ACK. If the WTRU cannot multiplex more than one ACK in a UCI report, the WTRU may omit the ACK for PDSCH, and may transmit the ACK for unified TCI only.

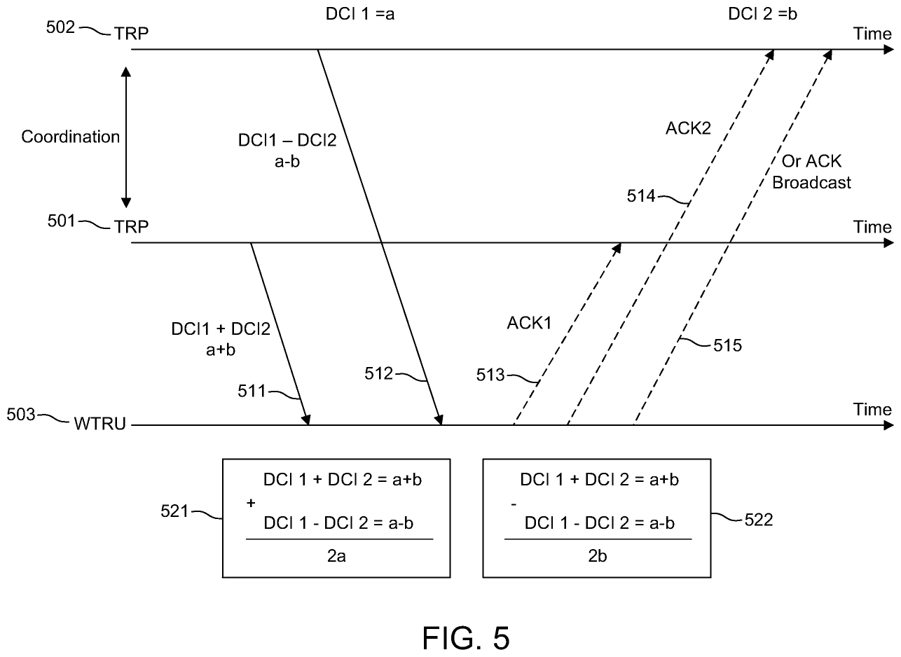

FIG. 5 illustrates an example of a reliability enhancement on receiving DCIs for unified TCIs. For this example, there may be multiple TRPs (e.g., TRP 501 and 502), a WTRU 503. Time is illustrates on the horizontal axis. There may be coordination between TRP 501 and TRP 502. The WTRU 503 may receive one or more configuration parameters for a DCI reception behavior/mode on receiving at least one DCI indicating unified TCI(s) (e.g., to enhance a reliability performance of unified TCIs for multiple TRPs, such as TRP 501 and TRP 502, e.g., with ideal backhaul coordination between the TRPs).

At 511, the WTRU 503 may (e.g., be configured to) receive a superposition of DCI 1 and DCI 2 from TRP 501 at some instant t1. The superposition of DCI 1 and DCI 2, expressed as DCI 1=a, DCI 2=b, may be performed as DCI 1+DCI 2=a+b (e.g., at a complex baseband modulation level). A power scaling factor ρ may be used to conform to the transmit power specification/scaling, such as DCI 1+DCI 2=ρ (a+b).

At 512, the WTRU 503 may also receive a difference of DCI 1 and DCI 2 from TRP2 at some instant t2, which may be expressed as DCI 1-DCI 2=ρ(a−b). The WTRU may perform the following procedures to estimate DC 1 and DC 2 as ρ(a+b)+ρ(a−b)=(2ρ)a, ρ(a+b)−ρ(a−b)=(2ρ)b.

Based on performing the procedures for estimating DCI 1 and DCI2, the WTRU may send ACK 1 (e.g., 513) and ACK 2 (e.g., 514) (e.g., both on PUSCH, both on PUCCH, one on PUSCH and another on PUCCH) to acknowledge the determination of DCI 1 and DCI 2. Alternately, the WTRU may broadcast/transmit a common/single ACK (e.g., 515) (e.g., on PUSCH or PUCCH) to acknowledge the determination of DCI 1 and DCI 2. The common ACK (e.g., 515) may reduce overhead whereas the reporting procedure may enhance the reliability performance of the unified TCIs. This may reduce signaling overhead pertaining to the ACK transmission in response to receiving at least one unified TCI. This may improve reliability of DCI transmissions, such as based on (e.g., temporal) diversity in receiving the DCI 1 and DCI 2.

In one case, one unified Transmission Configuration Indicator (TCI) (e.g., joint or a pair of separate DL/UL) may be indicated/maintained at a WTRU, to be applicable for both control/data channels simultaneously; this may be different from an individual beam control per channel.

In one case, there may be a Multi-DCI based MTRP (MDCI-MTRP) based on CORESETPoolIndex=0 or 1, to support eMBB. Further, there may be a Single-DCI based MTRP (SDCI-MTRP) based on associating up to two TCI-states for a codepoint of TCI field in a DCI, for repeated transmissions across TRPs, for reliability enhancements.

In one case, there may be an extension of the one unified TCI, which may be an indication of multiple DL and UL TCI states focusing on multi-TRP use case.

A WTRU may transmit a separate acknowledgement (ACK), from a HARQ-ACK for a PDSCH, in response to (e.g., successfully) receiving at least one unified TCI indication by a DCI scheduling the PDSCH, where the separate ACK may be for confirming the reception of the at least one unified TCI. A WTRU may transmit a separate ACK in response to (e.g., successfully) receiving at least one of a first unified TCI indicated by a first DCI scheduling a first PDSCH and a second unified TCI indicated by a second DCI scheduling a second PDSCH, where the separate ACK may be for confirming the reception of the at least one and be separated from a joint HARQ-ACK for the first PDSCH and the second PDSCH.

A WTRU may generate a HARQ-ACK codebook based on reception of at least one DCI that may indicate at least one united TCI, where the HARQ-ACK codebook may include at least one HARQ-ACK bit based on reception of a PDSCH scheduled by the at least one DCI and at least one bit based on successful reception of the at least one DCI indicating the unified TCI(s).

A WTRU may report the separate ACK when one or more predetermined (and/or configured) conditions are met, where the conditions may include at least one of: an indicated unified TCI in the scheduling DCI is different from the previous (e.g., currently used) one; a beam quality of the current common beam (e.g., united TCI) is below a threshold; at least one BFR-related condition being met; a PDSCH scheduling offset (and/or PUSCH scheduling offset) is larger than a threshold; a HARQ-ACK transmission timing (e.g., for PDSCH) is larger than a threshold; the number of repetitions for PDSCH (and/or PUSCH) is larger than a threshold; and/or, if negative ACK (NACK) is determined for the scheduled PDSCH.

In one example, a WTRU may receive an indication of a first TCI state (e.g., as a unified TCI). The WTRU may receive a first PDCCH based on the first TCI state where the first PDCCH may carry a first DCI scheduling a first PDSCH and indicate a second TCI state. If a time duration associated with at least one of the first PDSCH reception or the transmission of HARQ feedback associated with the first PDSCH is determined to be greater than a threshold, the WTRU may transmit a DCI-ACK, confirming reception of the first DCI.

The WTRU may apply or use the second TCI state (as a unified TCI applicable to multiple channel(s) and/or signal(s)) after a BAT parameter after transmitting the DCI-ACK as a new beam application timeline, based on transmitting the DCI-ACK.

In one case, a method may be implemented by a WTRU. The WTRU may receive an indication of a first TCI state. The WTRU may receive a first PDCCH transmission based on the first TCI state, wherein the first PDCCH transmission may include a first DCI. The first DCI may indicate scheduling information for a first PDCSCH and a second TCI state. The first DCI may also include timing for HARQ feedback associated with the first PDSCH. The WTRU may send a DCI-ACK, based on determining that a time duration is greater than a threshold; the time duration may be a period of time between receiving the PDCCH and a scheduled reception of the first PDSCH reception or a transmission of HARQ feedback associated with the first PDSCH. The DCI-ACK may confirm receipt of the first DCI. The DCI-ACK may be send using a first PUCCH resource; the first PUCCH resource may be determined based on RRC configuration or based on an indication in the first DCI. Sending the DCI-ACK may be further based on: determining the second TCI state is different from the first TC state; and/or, determining the first and second TCI states are unified TCI states; and/or, determining the first and second TCI states are unified TCI states, where each of the unified TCI states may apply to more than one channel type. The WTRU may receive the first PDSCH based on the first TCI state. The WTRU may transmit the HARQ feedback associated with the first PDSCH; the HARQ feedback may be send using a second PUCCH resource; after transmitting the HARQ feedback, the WTRU may receive a second PDCCH based on the second TCI state, wherein the second PDCCH includes a second DCI.

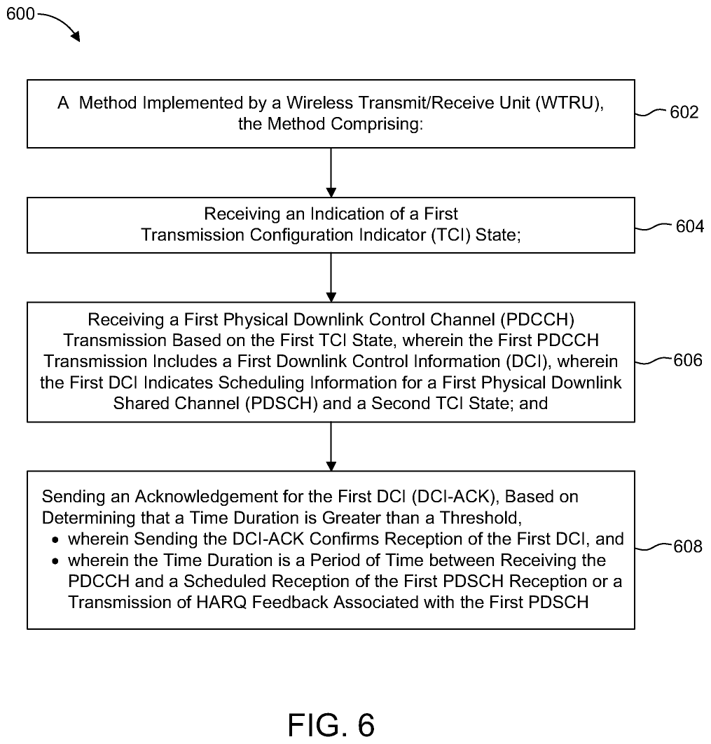

FIG. 6 illustrates an example process according to one or more techniques described herein. At 601, a wireless transmit/receive unit (WTRU), may receive an indication of a first transmission configuration indicator (TCI) state. At 602, the WTRU may receive a first physical downlink control channel (PDCCH) transmission based on the first TCI state, wherein the first PDCCH transmission includes a first downlink control information (DCI), and wherein the first DCI indicates scheduling information for a first physical downlink shared channel (PDSCH) and a second TCI state. The WTRU may send an acknowledgement for the first DCI (DCI-ACK), based on determining (e.g., on a condition) that a time duration is greater than a threshold. In one instance, sending the DCI-ACK confirms reception of the first DCI. In the same or another instance, the time duration may be a period of time between receiving the PDCCH and a scheduled reception of the first PDSCH reception and/or a transmission of HARQ feedback associated with the first PDSCH.

As described herein, a higher layer may refer to one or more layers in a protocol stack, or a specific sublayer within the protocol stack. The protocol stack may comprise of one or mom layers in a WTRU or a network node (e.g., eNB, gNB, other functional entity, etc.), where each layer may have one or mom sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or mom layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary ski in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. The terms set and group may be used interchangeably herein. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving an indication of a first transmission configuration indicator (TCI) state;
receiving a first physical downlink control channel (PDCCH) transmission based on the first TCI state, wherein the first PDCCH transmission includes a first downlink control information (DCI), wherein the first DCI indicates a second TCI state and scheduling information for a first physical downlink shared channel (PDSCH); and
on a condition that a time duration is greater than a threshold, sending an acknowledgement (DCI-ACK) for the first DCI and sending HARQ feedback associated with the first PDSCH after sending the DCI-ACK, wherein sending the DCI-ACK confirms reception of the first DCI, and wherein the time duration is a period of time between receiving the PDCCH and a scheduled reception of the first PDSCH reception or a transmission of HARQ feedback associated with the first PDSCH; and
on a condition that the time duration is not greater than the threshold, sending the HARQ feedback associated with the first PDSCH without sending the DCI-ACK.

2. The method of claim 1, wherein the HARQ feedback is sent using a second physical uplink control channel (PUCCH) resource.

3. The method of claim 1, wherein the DCI-ACK is sent using a first physical uplink control channel (PUCCH) resource, wherein the first PUCCH resource is determined based on a RRC configuration or based on an indication in the first DCI.

4. The method of claim 1, wherein sending the DCI-ACK confirming reception of the first DCI is further conditioned on determining the second TCI state is different from the first TCI state.

5. The method of claim 1, wherein sending the DCI-ACK confirming reception of the first DCI is further conditioned on determining the second TCI states is a unified TCI states, wherein the unified TCI states apply to more than one channel type.

6. The method of claim 1, further comprising receiving the first PDSCH based on the first TCI state.

7. An wireless transmit receive unit (WTRU), the WTRU comprising:
a processor operatively coupled to a transceiver, the processor and transceiver configured to receive an indication of a first transmission configuration indicator (TCI) state;
the processor and transceiver configured to receive a first physical downlink control channel (PDCCH) transmission based on the first TCI state, wherein the first PDCCH transmission includes a first downlink control information (DCI), wherein the first DCI indicates scheduling information for a first physical downlink shared channel (PDSCH) and a second TCI state and scheduling information for a first physical downlink shared channel (PDSCH); and
on a condition that a time duration is greater than a threshold, the processor and transceiver configured to send an acknowledgement (DCI-ACK) for the first DCI and sending HARQ feedback associated with the first PDSCH after sending the DCI-ACK, wherein sending the DCI-ACK confirms reception of the first DCI, and wherein the time duration is a period of time between receiving the PDCCH and a scheduled reception of the first PDSCH reception or a transmission of HARQ feedback associated with the first PDSCH; and
on a condition that the time duration is not greater than the threshold, the processor and transceiver configured to send the HARQ feedback associated with the first PDSCH without sending the DCI-ACK.

8. The WTRU of claim 7, wherein the HARQ feedback is sent using a second physical uplink control channel (PUCCH) resource.

9. The WTRU of claim 7, wherein the DCI-ACK is sent using a first physical uplink control channel (PUCCH) resource, wherein the first PUCCH resource is determined based on a RRC configuration or based on an indication in the first DCI.

10. The WTRU of claim 7, wherein sending the DCI-ACK confirming reception of the first DCI is further conditioned on determining the second TCI state is different from the first TCI state.

11. The WTRU of claim 7, wherein sending the DCI-ACK confirming reception of the first DCI is further conditioned on determining the second TCI states is a unified TCI states, wherein the unified TCI states apply to more than one channel type.

12. The WTRU of claim 7, further comprising means receiving the first PDSCH based on the first TCI state.
